(19) United States
(12) Patent Application Publication
(10) Pub. No.: US 2018/0306214 A1
(43) Pub. Date: Oct. 25, 2018

(54) SYSTEM FOR CONTROLLING A FLOW OF FLUID, FEEDING SYSTEM COMPRISING SUCH A CONTROL SYSTEM AND METHOD USING SUCH A FEEDING SYSTEM

(71) Applicant: L'Air Liquide, Societe Anonyme pour l'Etude et l'Exploitation des Procedes Georges Claude, Paris (FR)

(72) Inventors: Jan COBBAUT, Bruxelles (BE); Claude MAIRE, Chaleze (FR); Jean-Francois RAUCH, Saint Maur des Fosses (FR)

(73) Assignee: L'Air Liquide, Societe Anonyme pour l'Etude et l'Exploitation des Procedes Georges Claude, Paris (FR)

(21) Appl. No.: 15/768,277

(22) PCT Filed: Oct. 7, 2016
(86) PCT No.: PCT/FR2016/052586

§ 371 Date: Apr. 13, 2018

(30) Foreign Application Priority Data
Oct. 16, 2015 (FR) 1559835

(51) Int. Cl. F15B 20/00; B01J 4/00; F25J 1/02; F25J 3/02; F25J 3/04

(52) U.S. Cl. CPC F15B 20/008; F15B 2211/87; F25J 1/0234; F25J 1/0248; F25J 1/0256; F25J 3/0295; F25J 3/04824; F25J 3/04854; F15B 2211/6355; F15B 2211/8755; F15B 2211/8752; F15B 2211/8757; F25J 2240/40; F25J 2280/02; F25J 2280/20; F25J 2290/90; B01J 4/008

(57) ABSTRACT

The invention relates to a control system which comprises: a plurality of flow valves on channels of reaction fluid, which are i) in a closed position or ii) in an open position; a plurality of control pipes connected to a source of control fluid and to a respective control pipe, all or part of the flow valves switching to the closed position when the pressure of the control fluid in the control pipe drops below a predetermined threshold; a discharge pipe connected to the control pipes, in order to discharge the control fluid from the control pipes; a safety device connected i) to each control pipe and ii) to the discharge pipe and configured to have, selectively: i) a service configuration, wherein the control fluid flows to each control pipe, thus opening each flow valve, and ii) a safety configuration, wherein the control fluid is discharged through the discharge pipe, thus closing each flow valve.

### CROSS REFERENCE TO RELATED APPLICATIONS

This application is a § 371 of International PCT Application PCT/FR2016/052586, filed Oct. 7, 2016, which claims the benefit of FR1559835, filed Oct. 16, 2015, both of which are herein incorporated by reference in their entireties.

### FIELD OF THE INVENTION

The present invention concerns a control system for controlling the circulation of a reaction fluid. The present invention also concerns a feeding system comprising a control system of this kind. The present invention further concerns a feeding method employing a feeding system of this kind. It additionally concerns cryogenic distillation apparatus comprising a control system for controlling the circulation of at least one fluid intended for or resulting from distillation.

The present invention can be applied to any field necessitating control of the fluid of a reaction fluid in a reliable and safe manner. In particular, the present invention can be applied to the circulation of hazardous reaction fluids, for example toxic and/or flammable and/or explosive liquids or gases. Such liquids or gases include for example hydrocarbons (CnHm), oxygen, dihydrogen, carbon monoxide, carbon dioxide, air, nitrogen, argon or any mixture composed of at least one or more of those components.

### BACKGROUND

In the field of control of the circulation of a hazardous reaction fluid, there are known control systems comprising i) primary pipes connected to a control fluid source, for example a compressed air source, and ii) flow valves arranged on respective pipes in which the reaction fluid circulates. Each flow valve has i) a closed position and ii) an open position. Each flow valve can go either to the closed position (valve closed by absence of control fluid) or the open position (valve opened by absence of control fluid) if the pressure of the compressed air in the respective primary pipe becomes zero.

In the field of reaction fluid flow safety, there are known all-or-nothing control systems that block or maximize the flow of reaction fluid by means of control valves that are either completely open or completely closed according to the pressure of the control fluid in the primary pipe. To combine the control function and the safety function, the known control systems sometimes comprise one or two safety solenoid valves for each flow valve. Each safety solenoid valve is arranged on the primary pipe so as to control, on the one hand, the rapid passage of the control fluid to the flow valve, and on the other hand, the rapid escape of the control fluid from the primary pipe. Each safety solenoid valve therefore enables selective control of the opening and the closing of each flow valve, therefore the passage or the blocking of the reaction fluid in the channel.

However, there is a risk of each safety solenoid valve becoming faulty or failing, because safety solenoid valves can suffer electrical power supply faults or electromagnetic interference, preventing them from operating correctly. To ensure redundancy of the safety function, a prior art control system therefore necessitates a second safety solenoid valve as well as a system for detecting failure of each safety solenoid valve.

Moreover, control systems of the above kind are costly, because they necessitate one or even two safety solenoid valves for each flow valve. Now each safety solenoid valve induces a direct or induced cost of approximately 1000 €. In a complete control system, several tens of safety solenoid valves therefore induce a cost of several tends of thousand euros.

### SUMMARY OF THE INVENTION

An aim of the present invention is in particular to solve some or all of the problems referred to above.

To this end, certain embodiments of the present invention include in particular in a control system, for controlling the circulation of at least one reaction fluid in a reaction fluid feeding system, the control system comprising:
a plurality of flow valves configured to be arranged on respective channels intended to convey at least one reaction fluid, each of said flow valves being configured to have at least: i) a closed position and ii) an open position in which said at least one reaction fluid can circulate in the respective channel,
a plurality of control pipes intended to be connected to a control fluid source, the control fluid being for example compressed air, each of said flow valves being connected to a respective control pipe, a plurality of said flow valves being configured to go to the closed position if the pressure of the control fluid in the respective control pipes is below a predetermined threshold,

the control system further includes:
at least one evacuation pipe connected to each of said control pipes, so as to allow evacuation of the control fluid from each control pipe,
a safety device connected i) to each control pipe and ii) to said at least one evacuation pipe, the safety device being configured to have selectively:
i) at least one service configuration, in which the control fluid can circulate as far as each control pipe so that each of said flow valves can be placed in a respective open position, and
ii) a safety configuration, in which the control fluid can circulate from each of said flow valves through said at least one evacuation pipe so that each of said flow valves is placed in the closed position if the pressure of the control fluid in said control pipes is below the predetermined threshold.

A control system of the above kind therefore has a greatly reduced cost, whilst offering great reliability. Actually, in a control system of the above kind, it is not indispensable to equip each flow valve with one or more safety solenoid valves, because the safety device guarantees the passage of each flow valve to the closed position if the control system is operating in the normal mode or if the control system is operating in the failure mode, that is to say with a low or zero control fluid pressure.

Actually, when the safety device is in the service configuration, the control fluid circulates from the control fluid source to each control pipe, which makes it possible if necessary to place each control pipe in the open position, because the pressure of the control fluid in each control pipe is above the predetermined threshold. When the safety device is in the service configuration, there is no or insignificant flow of control fluid through the evacuation pipe.

When the safety device is in the safety configuration, the control fluid circulates from each control pipe to the evacuation pipe, which enables each flow valve to be placed in the closed position, because the pressure of the control fluid in each control pipe falls below the predetermined threshold. When the safety device is in the safety configuration, there is no or insignificant flow of control fluid through each control pipe, and the reaction fluid therefore stops circulating in the channels.

If the control valve and the evacuation valve are no longer supplied with control fluid, for example because of a failure occurring in the control fluid supply, then the safety device goes to the safety configuration, which brings the flow valves to the closed position. In the present application, the term “fluid” designates in particular single-phase (gas or liquid) fluids or multiphase fluids, for example containing solid particles. In the present application, the term “reaction fluid” designates a fluid intended to undergo any treatment, for example a chemical or electrochemical reaction, a physical or other treatment. The treatment undergone can modify the state and/or the composition of the reaction fluid or not.

In the present application, the term “closed position” designates a position in which the normally closed valve prevents the circulation of the reaction fluid in the channel. In the present application, the term “open position” designates a position in which the valve allows the circulation of the reaction fluid in the channel.

In the present application, the term “connect” or any of its derivatives concerns establishing fluid, liquid or gas, communication between at least two components, that is to say establishing communication allowing a circulation of fluid between those two components, in one direction and/or in the opposite direction. Establishing fluid communication can be effected via the intermediary of no, one or several intermediate elements.

In the present application, the term “connect” designates any connection enabling an exchange of signals. A connection can be made with or without electrical wires. A connection can be made with no, one or several intermediate electrical elements.

According to one variant, the flow valve is a normally closed valve. Alternatively, the flow valve is a normally open valve. In the present application, the term “normally closed valve” designates a valve closed by absence of control fluid, thus a circuit cut-off valve. In the present application, the term “normally open valve” designates a valve open by absence of control fluid, thus a circuit establishing valve.

According to a variant, the safety device comprises at least one electrical actuator configured to place the safety device alternately in the service configuration and in the safety configuration.

According to a variant, the number of flow valves is greater than 20. For example, the number of flow valves can be equal to 40.

According to a variant, the control system further comprises at least one feed valve configured to be arranged on a channel intended to convey the reaction fluid, said at least one feed valve being configured to have at least: i) a closed position and ii) an open position in which the reaction fluid can circulate in the channel,

said at least one feed valve being configured to go to the open position if the pressure of the control fluid in the respective control pipe is below a predetermined threshold.

A feed valve of the above kind can for example be an anti-hunting valve of a compressor that serves to protect the compressor, by ensuring that the output of the compressor is open if the pressure of the control fluid in the control pipe falls below a predetermined threshold.

According to a variant, the channels can be configured and arranged to convey at least two different reaction fluids.

A single flow valve is preferably configured to be arranged on each respective channel intended to convey at least one reaction fluid.

According to one embodiment, the safety device comprises a safety solenoid valve having at least three ports, the three ports including:
i) a first port intended to be connected to the control fluid source,
ii) a second port connected to the control pipes, and
iii) a third port connected to said at least one evacuation pipe;

the safety device being configured to place the safety solenoid valve alternately:
in a service configuration, in which the first port is connected to the second port, and
a safety configuration, in which the second port is connected to the third port.

In other words, the safety device comprises a safety solenoid valve with (at least) three ports that can convey:
the control fluid arriving from the control fluid source to the control pipes, therefore to the flow valves, and
the control fluid arriving from the control pipes, therefore the flow valves, to the or each evacuation pipe.

A safety solenoid valve of the above kind therefore has a simple, compact and economic structure, at the same time as enabling feeding of the control fluid to the flow valves.

According to a variant, said at least one safety solenoid valve can be a distributor with three ports and two positions. A distributor of this kind with three ports and two positions forms a unit including a blocking member that is selectively moved between the two positions to connect two of the three ports.

Alternatively, said at least one safety solenoid valve can be a distributor having more than three ports and/or more than two positions.

According to one embodiment, the safety device comprises at least:
an auxiliary control pipe intended to be connected to the control fluid source,
at least one control valve connected to each control pipe, said at least one control valve comprising a blocking member connected to the auxiliary control pipe, the blocking member being configured to place said at least one control valve selectively i) in a closed position and ii) in at least one open position, said at least one control valve being configured to go to the closed position if the pressure of the control fluid in the auxiliary control pipe is below a predetermined safety threshold,
an auxiliary evacuation pipe intended to be connected to the control fluid source, and
at least one evacuation valve on said at least one evacuation pipe, said at least one evacuation valve comprising a blocking member connected to the auxiliary evacuation pipe, the blocking member being configured to place said at least one evacuation valve selectively i) in a closed position and ii) in at least one open position, said at least one evacuation valve being configured to go to the open position if the pressure of the control fluid in the auxiliary evacuation pipe is below a predetermined evacuation threshold.

Control and evacuation valves of the above kind therefore enable production of a reliable safety device, because the control valve and the evacuation valve can be independent of one another, which enables one of them to be actuated even if the other has failed.

According to one embodiment, said at least one auxiliary control pipe is equipped with an auxiliary control solenoid valve having i) a passage position, in which the control fluid circulates in said at least one auxiliary control pipe, and ii) an escape position, in which the control fluid escapes from said at least one auxiliary control pipe,

the auxiliary control solenoid valve being configured to go from the passage position to the escape position if the electrical power supply of the respective auxiliary control solenoid valve is interrupted.

An auxiliary control solenoid valve of the above kind therefore enables rapid stopping of the arrival of the control fluid in the control pipes, and therefore rapid closing of each flow valve, and thus rapid interruption of the flows of reaction fluids.

According to one embodiment, the safety device comprises:
first and second control sections arranged in parallel and each connected to said control pipes,
first and second control valves arranged in parallel on the control sections,
first and second auxiliary control pipes arranged in parallel, and
first and second auxiliary control solenoid valves that are intended to be connected to the control fluid source and are respectively arranged on the first auxiliary control pipe and on the second auxiliary control pipe so as respectively to control the first control valve and the second control valve.

In other words, the safety device is duplicated, which ensures redundancy of the control and evacuation functions that here are respectively implemented by the two control valves and by the two evacuation valves.

The auxiliary control solenoid valves thus enable rapid actuation of the first and second control valves.

According to one embodiment, the control system further comprises first and second auxiliary control sensors configured to generate a respective failure signal if the first and/or the second control valve does not reach its respective open position.

First and second auxiliary control sensors of the above kind therefore improve the reliability of the safety device, because they enable redundancy in the surveillance of the normal operation of the control valves. In the event of failure of either the first or the second control valve, the other can implement the control function.

In the present application, the term “presence in closed position” signifies that the valve, in this instance one of the first and second control valves, is in the closed position; in other words, this term signifies that the valve is closed.

According to a variant, the first auxiliary control sensor is configured to generate a failure signal if the first control valve is not in the open position and the second auxiliary control sensor is configured to generate a failure signal if the second auxiliary control valve is not in the open position. The first and second auxiliary control sensors can take the form of open end of travel sensors.

On the occurrence of a failure signal, a maintenance operative intervenes to return the failed control valve to service or to replace it.

According to one embodiment, said at least one auxiliary evacuation pipe is equipped with an auxiliary evacuation solenoid valve having i) a passage position, in which the control fluid circulates in said at least one auxiliary evacuation pipe, and ii) an escape position, in which the control fluid escapes from said at least one auxiliary evacuation pipe,

said at least one auxiliary evacuation solenoid valve being configured to go from the passage position to the escape position if the electrical power supply of said at least one auxiliary evacuation solenoid valve is interrupted.

An auxiliary evacuation solenoid valve of the above kind therefore enables rapid evacuation of the control fluid from the auxiliary evacuation pipe, which enables rapid evacuation of the control fluid from the pipe, thus rapid closing of each flow valve, and therefore rapid interruption of the reaction fluid flows.

According to one embodiment, the control system comprises:
first and second evacuation valves arranged in series on the same evacuation pipe,
first and second auxiliary evacuation pipes arranged in parallel,
first and second auxiliary evacuation solenoid valves respectively arranged on the first auxiliary evacuation pipe and on the second auxiliary evacuation pipe so as respectively to control the first evacuation valve and the second evacuation valve.

Each of the evacuation valves can therefore operate independently, which increases the reliability of the control system. Actually, the two evacuation valves must open to enable the evacuation of the control fluid and thus the or each flow valve to be placed in the closed position, therefore to interrupt the flow of the reaction fluid in the or each channel. Moreover, the first and second evacuation solenoid valves enable rapid actuation of the first and second evacuation valves.

According to one embodiment, the control system further comprises first and second auxiliary evacuation sensors respectively arranged on the first and second evacuation valves, the first and second auxiliary evacuation sensors being configured so as to generate a respective failure signal if the first and/or the second evacuation valve does not reach its respective closed position.

The first and second auxiliary evacuation sensors can take the form of closed end of travel sensors.

On the occurrence of a failure signal, a maintenance operative intervenes to return the failed evacuation valve to service or to replace it.

Thus if the first evacuation valve has failed and opens despite a command to close it, then the first auxiliary evacuation sensor detects that failure.

According to a variant, the first and second auxiliary evacuation sensors can be first and second end of travel sensors arranged to detect the respective end of closing travel of the first evacuation valve and the second evacuation valve.

According to one embodiment, at least one of said flow valves is configured to have i) a closed position and ii) a single open position, said at least one flow valve being configured to go to the open position if the pressure of the control fluid in the respective control pipe is below a predetermined threshold.

A flow valve of the above kind therefore operates on an all-or-nothing basis, because its open position enables a full flow of the reaction fluid in a respective channel and because its closed position enables interruption of the flow of the reaction fluid in a respective channel.

In an alternative to the above embodiment, all the flow valves can be configured to go to the closed position if the pressure of the control fluid in the respective control pipes is below a predetermined threshold.

According to one embodiment, the control system further comprises a plurality of regulation members, each regulation member being configured to regulate the pressure of the control fluid in a respective control pipe, so as selectively to place the respective flow valve in a plurality of open positions.

A regulation member of the above kind therefore enables the flow valve to regulate the reaction fluid flow in the channel. The degree of opening of the flow valve is a function of the pressure of the control fluid in the or each secondary pipe. For example, the degree of opening of the flow valve can be proportional to the pressure of the control fluid in the or each secondary pipe.

According to a variant, the regulation valve is configured to receive regulation signals and to move a blocking member as a function of the regulation signals. The regulation signals are sent by a central control unit, which can for example take the form of a computer.

The control signals can be electrical currents of between 4 mA and 20 mA. The regulation member can comprise an electromagnetic actuator.

A feeding system of the above kind can therefore operate with great reliability, which is particularly important for reaction fluids representing risks to the safety of persons or goods.

Moreover, the present invention consists in a reaction fluid feeding system, for feeding with at least one reaction fluid at least one consumption member, a reaction fluid being for example a hydrocarbon, the reaction fluid feeding system comprising at least:
a container configured to contain the reaction fluid,
a plurality of channels connected to said at least one container and configured for the circulation of said at least one reaction fluid,
a control system according to the invention, each flow valve being adapted selectively to prevent or to allow the circulation of said at least one reaction fluid in a respective channel, and
a control fluid source configured to supply a control fluid to the control system.

A reaction fluid feeding system of the above kind therefore offers great safety of operation. Actually, the first and second flow valves enable double cut-off or isolation on the same channel and the escape valve enables the reaction fluid to be directed to a reject channel in the event of failure in a part situated on the downstream side of the system.

According to one embodiment, the reaction fluid feeding system comprises first and second channels that are connected at a junction point, the control system comprising first and second flow valves arranged on the first channel on respective opposite sides of the junction point,

each of the flow valves being configured to have i) a closed position and ii) at least one open position, the flow valves being configured to go to the closed position if the pressure of the control fluid in the respective control pipe is below a predetermined pressure,

the control system further comprising an escape valve arranged on the second channel so as to convey said at least one reaction fluid in the second channel, the second channel being intended to be connected to a reject port,

the escape valve being connected to a control pipe, the escape valve being configured to have i) a closed position and ii) at least one open position, the escape valve being configured to go to the open position if the pressure of the control fluid in the control pipe is below a predetermined pressure.

A feeding method of the above kind therefore enables very safe operation of the feeding system.

According to a variant, the reject port can discharge into a standby container, a chimney leading to the atmosphere or a flare stack.

Also, the present invention consists in a method for feeding at least one consumption member with at least one reaction fluid, said at least one reaction fluid being for example a hydrocarbon, the feeding method comprising the steps of:
providing a reaction fluid feeding system according to the invention,
connecting each of said control pipes to the control fluid source,
placing the safety device in the service configuration,
subjecting each of said control pipes to a control fluid pressure above a predetermined threshold, so as to place each flow valve in a respective open position, and thus to convey said at least one reaction fluid in the channels.

A feeding method of the above kind therefore enables feeding of reaction fluid to consuming members at lower cost and with improved reliability.

According to the invention, a method for separation of air by cryogenic distillation comprises a control system as claimed in any one of claims 1 to 11.

The embodiments and the variants referred to above can be considered separately or in any technically possible combination.

### BRIEF DESCRIPTION OF THE DRAWINGS

The present invention will be clearly understood and its advantages will also emerge in the light of the following description given by way of nonlimiting example only and with reference to the appended figures, in which identical reference signs correspond to elements that are structurally and/or functionally identical or similar. In these appended figures:

FIG. 1 is a diagrammatic view of a reaction fluid feeding system that conforms to a first embodiment and comprises a control system that conforms to the first embodiment;

FIG. 2 is a diagrammatic view of a flow valve belonging to the control system from FIG. 1, in the open position; this flow valve is closed by absence of control fluid;

FIG. 3 is a diagrammatic view of the flow valve from FIG. 2, in the closed position;

FIG. 4 is a diagrammatic view of a reaction fluid feeding system that conforms to a second embodiment and comprises a control system that conforms to the second embodiment;

FIG. 5 is a diagrammatic view of an evacuation valve of the control system from FIG. 2, in the closed position; this evacuation valve is opened by absence of control fluid;

FIG. 6 is a diagrammatic view of the evacuation valve from FIG. 5, in the open position;

FIG. 7 is a diagrammatic view of a reaction fluid feeding system that conforms to a third embodiment and comprises a control system that conforms to the third embodiment;

FIG. 8 is a diagrammatic view of a reaction fluid feeding system that conforms to a fourth embodiment and comprises a control system that conforms to the fourth embodiment; and

FIG. 9 is a flowchart illustrating a feeding method according to the invention.

### DETAILED DESCRIPTION OF THE INVENTION

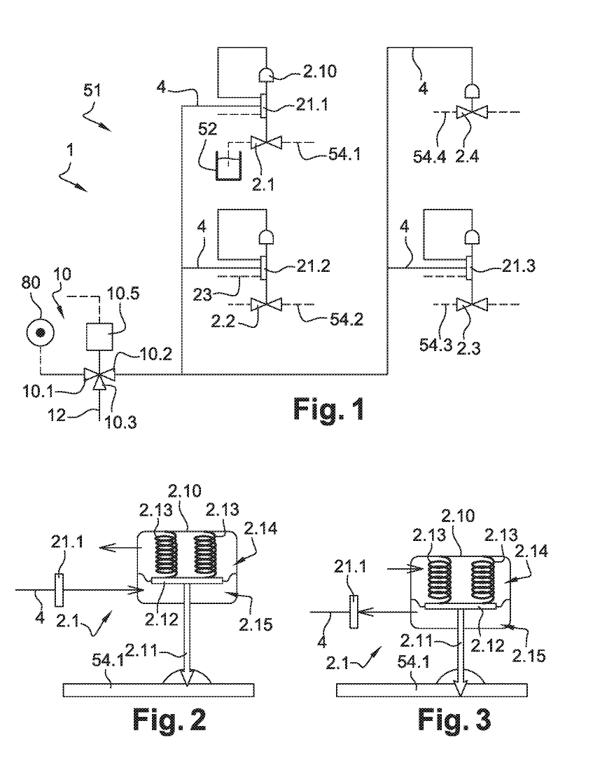

FIG. 1 illustrates a reaction fluid feeding system 51 comprising a control system 1. The reaction fluid feeding system 51 has in particular the function of feeding reaction fluid to one or more consuming members not shown. Here the reaction fluid is a hydrocarbon (CnHm), for example.

The control system 1 has in particular the function of controlling the circulation of a reaction fluid in a reaction fluid feeding system. The control system 1 comprises a plurality of flow valves 2.1, 2.2, 2.3 and 2.4 and a plurality of control pipes 4.

The flow valves 2.1, 2.2, 2.3 and 2.4 are configured to be arranged on respective channels 54.1, 54.2, 54.3 and 54.4 intended to convey the reaction fluid. Each of the flow valves 2.1, 2.2, 2.3 and 2.4 is configured to have i) a closed position and ii) an open position.

For example each channel can contain a flow of the same fluid or the channels can contain flows of different composition. For example, in air distillation apparatus, the channel 54.1 can be a liquid nitrogen channel, the channel 54.2 can be a channel for air to be separated, the channel 54.3 can be a channel for liquid enriched with oxygen that has been evaporated and the channel 54.4 can be a channel for a liquid rich in oxygen.

When a flow valve is in the closed position, the reaction fluid cannot circulate in the respective channel 54.1, 54.2, 54.3 or 54.4. When a flow valve is in the open position, the reaction fluid can circulate in the respective channel 54.1, 54.2, 54.3 or 54.4.

The control pipes 4 are intended to be connected to a control fluid source 80. Here the control fluid is compressed air, for example. Each flow valve 2.1, 2.2, 2.3 and 2.4 is connected to a respective control pipe 4. A plurality of the flow valves 2.1, 2.2, 2.3 and 2.4 are configured to go to the fully closed (no flow) position if the pressure of the control fluid in the respective control pipes 4 is below a predetermined threshold (valve closed by absence of control fluid or normally closed valve). This predetermined threshold can be for example a control fluid pressure below 3 bar relative or 2 bar relative.

The control system 1 further comprises an evacuation pipe 12 that is connected to each of the control pipes 4, so as to enable evacuation of the control fluid from each control pipe 4.

Moreover, the control system 1 comprises a safety device 10 that is connected i) to each control pipe 4 and ii) to the evacuation pipe 12. The safety device 10 is configured selectively to adopt:

i) a service configuration, in which the control fluid can circulate to each control pipe 4 so that each of the valves 2.1, 2.2, 2.3 and 2.4 can be placed in a respective open position, and

ii) a safety configuration, in which the control fluid can circulate from each of the flow valves 2.1, 2.2, 2.3 and 2.4 through the evacuation pipe 12 so that said flow valves 2.1, 2.2, 2.3 or 2.4 are placed in the closed position if the pressure of the control fluid in the respective control pipes 4 is below the predetermined threshold.

In the FIG. 1 example, the safety device 10 comprises a safety solenoid valve having three ports, the three ports including:

i) a first port 10.1 connected to the control fluid source 80,

ii) a second port 10.2 connected to the control pipes 4, and

iii) a third port 10.3 connected to the evacuation pipe 12.

The safety device 10 is configured to place the safety solenoid valve alternately:
in a service configuration, in which the first port 10.1 is connected to the second port 10.2, and
in a safety configuration, in which the second port 10.2 is connected to the third port 10.3.

The safety solenoid valve forming the safety device 10 is formed here by a distributor with three ports and two positions (usually termed a “3/2” distributor). The safety solenoid valve comprises a blocking member not shown that is selectively moved between the two positions to connect two of the three ports: either the first port 10.1 and the second port 10.2, when the safety device 10 is in the service configuration, or the second port 10.2 and the third port 10.3, when the safety device 10 is in the safety configuration.

To move the blocking member between its two positions, the safety solenoid valve comprises an electric actuator 10.5 that can be controlled by a control signal, for example in the form of an electric voltage of 0 or 24 V.

One of the flow valves 2.1, 2.2, 2.3 and 2.4 can be configured to have i) a closed position and ii) a single open position, for example like the flow valve 2.4 represented top right in FIG. 1. This flow valve 2.4 is configured to go to the open position if the pressure of the control fluid in the respective control pipe 4 is above a predetermined threshold. This predetermined threshold can for example be a control fluid pressure greater than 2 bar relative or 3 bar relative.

The control system 1 can further comprise a plurality of regulation members 21.1, 21.2 and 21.3 that are configured to regulate the pressure of the control fluid in the respective control pipes 4. By regulating the pressure of the control fluid, the regulation members 21.1, 21.2 and 21.3 enable selective placement of the respective flow valves 2.1, 2.2, 2.3 and 2.4 in their open position. Here each regulation member 21.1, 21.2 and 21.3 is controlled by a control signal that can for example be conveyed by an electric current of 4-20 mA, for example via a wire 23.

The reaction fluid feeding system 51 further comprises a container 52 of reaction fluid and a control fluid source 80 for the control system 1. The reaction fluid container 52 can be any type of reaction fluid source.

Moreover, the reaction fluid feeding system 51 comprises a plurality of channels 54.1, 54.2, 54.3 and 54.4 that are connected to the container 52 and are configured for the circulation of the reaction fluid. In the FIG. 1 example, each channel 54.1, 54.2, 54.3 and 54.4 is connected to the same container 52. Alternatively, the reaction fluid feeding system can comprise channels connected to respective containers containing different reaction fluids.

When the reaction fluid feeding system 51 is in service, the safety device 10 is in the service configuration, so that each flow valve 2.1 to 2.4 can selectively prevent or allow the circulation of the reaction fluid in the respective channels 54.1, 54.2, 54.3 and 54.4 as a function of control signals transmitted for example via the wire 23 and the like.

In service the reaction fluid feeding system 51 functions in accordance with a feeding method 1000 according to the invention and illustrated in FIG. 9. The feeding method 1000 has in particular the function of feeding one or more consuming members with reaction fluid.

The feeding method 1000 comprises the steps of:
1002) supplying the feeding system with reaction fluid 51,
1004) connecting each control pipe 4 to the control fluid source 80,
1006) placing the safety device 10 in the service configuration,
1008) subjecting each control pipe 4 to a control fluid pressure above the predetermined threshold, so as to place each flow valve 2.1, 2.2, 2.3 and 2.4 in the respective open position, and thus to convey the reaction fluid in the channels 54.1, 54.2, 54.3 and 54.4.

As FIGS. 1 and 2 show, a flow valve 2.1 comprises a control part 2.10 and a blocking member 2.11. FIGS. 2 and 3 diagrammatically illustrate the structure and the operation of the flow valve 2.1, 2.2, 2.3 and 2.4 arranged on a respective channel 54.1, 54.2, 54.3 or 54.4. The blocking member 2.11 is mobile between:
an open position (FIG. 2) of the flow valve 2.1, in which the blocking member 2.11 allows the reaction fluid to circulate in the channel 54.1, and
a closed position (FIG. 3) of the flow valve 2.1, in which the blocking member 2.11 prevents the reaction fluid from circulating in the channel 54.1.

The control part 2.10 has a first chamber 2.14 and a second chamber 2.15, which are volumes variable as a function of the pressure of the control fluid conveyed by the control pipe 4. The first chamber 2.14 is connected to the control pipe 4 via the regulation member 21.

The control part 2.10 comprises a piston 2.12 and a return member 2.13. The piston 2.12 is disposed between the first chamber 2.14 and the second chamber 2.15. The piston 2.12 is mechanically connected to the blocking member 2.11, with the result that the piston 2.12 moves the blocking member 2.11 between the open position (FIG. 2) and the closed position (FIG. 3). The return member 2.13 is adapted to push on the piston 2.12 so as to place the flow valve 2.1 in the closed position (FIG. 3).

To place the flow valve 2.1 in the open position (FIG. 2), a control fluid pressure above the particular threshold is applied in the control pipe 4 and in the second chamber 2.15, therefore on the piston 2.12 and against the return member 2.13. The reaction fluid can then circulate in the channel 54.1, the safety device 10 being placed in the service configuration.

When the pressure of the control fluid in the control pipe 4 is released, the pressure of the control fluid then falls below the particular threshold. The return member 2.13 then pushes back the piston 2.12 and the blocking member 2.11, which places the flow valve 2.1 in the closed position (FIG. 3). This is the case for example if the safety device 10 is placed in the safety configuration.

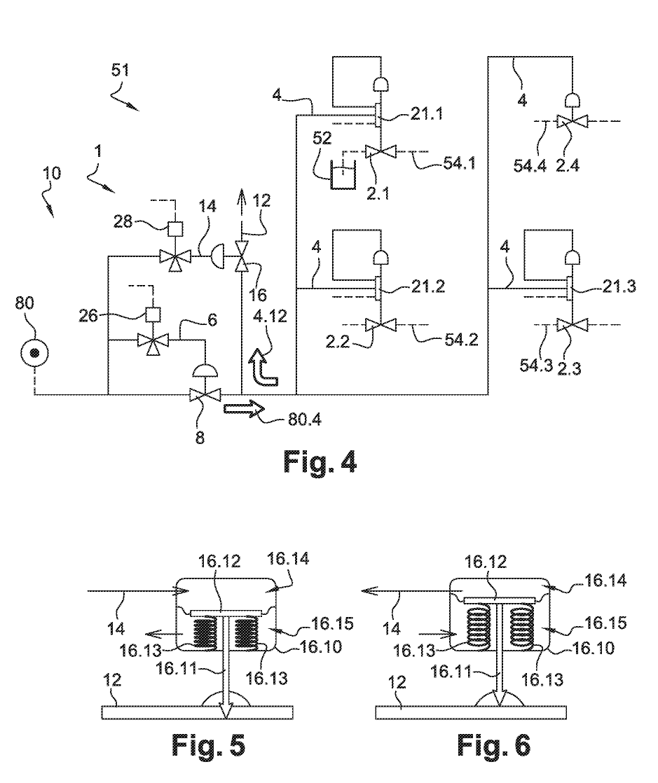

FIG. 4 shows a reaction fluid feeding system 51 conforming to a second embodiment and comprising a control system 1 conforming to the second embodiment. To the degree that the reaction fluid feeding system 51 and the control system 1 from FIG. 4 are similar to the reaction fluid feeding system 51 and to the control system 1 from FIG. 1, the description of the reaction fluid feeding system 51 and the control system 1 given above with reference to FIG. 1 can be transposed to the reaction fluid feeding system 51 and to the control system 1 from FIG. 4, with the exception of the significant differences stated below.

The reaction fluid feeding system 51 and the control system 1 from FIG. 4 thus comprise flow valves 2.1, 2.2, 2.3 and 2.4, control pipes 4, a safety device 10, an evacuation pipe 12, a container 52 with the reaction fluid, channels 54.1, 54.2, 54.3 and 54.4 and a control fluid source 80.

The reaction fluid feeding system 51 from FIG. 4 differs from the reaction fluid feeding system 51 from FIG. 1 in particular because the control system 1 from FIG. 4 differs from the control system 1 from FIG. 1. The control system 1 from FIG. 4 differs from the control system 1 from FIG. 1 in particular because the safety device 10 from FIG. 4 differs from the safety device 10 from FIG. 1. Actually, the safety device 10 comprises an auxiliary control pipe 6, a control valve 8, an auxiliary evacuation pipe 14 and an evacuation valve 16.

The auxiliary control pipe 6 is connected to the control fluid source 80. The control valve 8 is connected to each control pipe 4. The control valve 8 comprises a blocking member connected to the auxiliary control pipe 6.

The blocking member is configured to place the control valve 8 selectively i) in a closed position and ii) in an open position. The control valve 8 is configured to go to the closed position if the pressure of the control fluid in the auxiliary control pipe 6 is below a predetermined safety threshold, for example below 2 or 3 bar relative. The control valve 8 thus functions in the manner of the flow valve 2.1 shown in FIGS. 2 and 3 (valve closed by absence of control fluid).

When the reaction fluid feeding system 51 from FIG. 4 is assembled with the control system 1 the auxiliary evacuation conduit 14 is connected to the control fluid source 80.

The evacuation valve 16 is arranged on the evacuation pipe 12. The evacuation valve 16 comprises a blocking member that is connected to the auxiliary evacuation pipe 14. The blocking member is configured selectively to place the evacuation valve 16 in a closed position and ii) in an open position. The evacuation valve 16 is configured to go to the open position if the pressure of the control fluid in the auxiliary evacuation pipe 14 is below a predetermined evacuation threshold, for example 2 or 3 bar relative.

FIGS. 5 and 6 illustrate diagrammatically the structure and the operation of the evacuation valve 16. The evacuation valve 16 comprises a control part 16.10 and a blocking member 16.11. The evacuation valve 16 is arranged on the evacuation pipe 12. The blocking member 16.11 is mobile between:
a closed position (FIG. 5) of the evacuation valve 16, in which the blocking member 16.11 prevents the reaction fluid from circulating in the evacuation pipe 12, and
an open position (FIG. 6) of the evacuation valve 16, in which the blocking member 16.11 allows the reaction fluid to circulate in the evacuation pipe 12.

The control part 16.10 includes a first chamber 16.14 and a second chamber 16.15, which are volumes variable as a function of the pressure of the control fluid conveyed by the auxiliary control pipe 14. The first chamber 16.14 is connected to the auxiliary control pipe 14.

The control part 16.10 comprises a piston 16.12 and a restoring member 16.13. The piston 16.12 is disposed between the first chamber 16.14 and the second chamber 16.15. The piston 16.12 is mechanically connected to the blocking member 16.11, with the result that the piston 16.12 moves the blocking member 16.11 between the open position (FIG. 6) and the closed position (FIG. 5). The restoring member 16.13 is adapted to push on the piston 16.12 so as to place the evacuation valve 16 in the open position (FIG. 6).

To place the evacuation valve 16 in the closed position (FIG. 5), there is applied in the auxiliary control pipe 14 and in the second chamber 16.15, therefore on the piston 16.12 and against the restoring member 16.13, a control fluid pressure greater than the particular threshold. The control fluid is then unable to circulate in the evacuation pipe 12, the safety device 10 being placed in the service configuration.

Then, when the pressure of the control fluid in the auxiliary control pipe 14 is released, the pressure of the control fluid falls below the particular threshold. The restoring member 16.13 then pushes on the piston 16.12 and the blocking member 16.11, which places the evacuation valve 16 in the open position (FIG. 6). This is for example the case if the safety device 10 is placed in the safety configuration.

The auxiliary control pipe 6 is equipped with an auxiliary control solenoid valve 26 that has i) a passage position, in which the control fluid circulates in the auxiliary control pipe 6, and ii) an escape position, in which the control fluid escapes from the auxiliary control pipe 6. The auxiliary control solenoid valve 26 is configured to go from the passage position to the escape position if the electrical power supply of the auxiliary control solenoid valve 26 is interrupted.

Likewise, the auxiliary evacuation pipe 14 is equipped with an auxiliary evacuation solenoid valve 28 that has i) a passage position, in which the control fluid circulates in the auxiliary evacuation pipe 14, and ii) an escape position, in which the control fluid escapes from the auxiliary evacuation pipe 14. The auxiliary evacuation solenoid valve 28 is configured to go from the passage position to the escape position if the electrical power supply of the auxiliary evacuation solenoid valve 28 is interrupted.

When the reaction fluid feeding system 51 is in service, the safety device 10 is in the service configuration. The control valve 8 is then open or passing, whereas the evacuation valve 16 is closed, with the result that the control fluid circulates from the control fluid source 80 in the control pipes 4 and to the flow valves 2.1, 2.2, 2.3 and 2.4, in the direction indicated by the arrow 80.4 in FIG. 4.

In the event of an incident, the safety device 10 go to the safety configuration. The control valve 8 is then closed, whereas the evacuation valve 16 is open, with the result that the control fluid is evacuated from the control pipes 4 and through the evacuation pipe 12, in the direction indicated by the arrow 4.12 in FIG. 4.

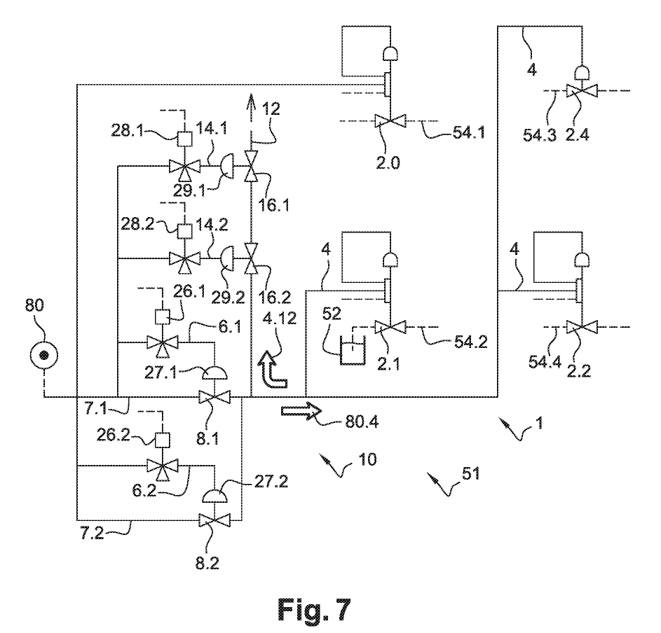

FIG. 7 illustrates a reaction fluid feeding system 51 conforming to a third embodiment and comprising a control system 1 conforming to the third embodiment. To the extent that the reaction fluid feeding system 51 and the control system 1 from FIG. 7 are similar to the reaction fluid feeding system 51 and to the control system 1 from FIG. 4, the description of the reaction fluid feeding system 51 and of the control system 1 given above in relation to FIGS. 4 to 6 can be transposed to the reaction fluid feeding system 51 and to the control system 1 from FIG. 7, with the exception of the significant differences stated below.

The reaction fluid feeding system 51 and the control system 1 from FIG. 7 therefore comprise flow valves 2.1, 2.2 and 2.4, control pipes 4, a safety device 10, an evacuation pipe 12, a container 52 containing reaction fluid, channels 54.1, 54.2, 54.3 and 54.4 and a control fluid source 80.

The reaction fluid feeding system 51 from FIG. 7 differs from the reaction fluid feeding system 51 from FIG. 4, in particular because the control system 1 differs from the control system 1. The control system 1 from FIG. 7 differs from the control system 1 from FIG. 4, in particular because the safety device 10 from FIG. 7 differs from the safety device 10 from FIG. 4. Actually, the safety device 10 from FIG. 7 comprises:
first and second control sections 7.1 and 7.2 arranged in parallel and each connected to the control pipes 4,
first and second control valves 8.1 and 8.2 arranged in parallel on the first and second control sections 7.1 and 7.2,
first and second auxiliary control pipes 6.1 and 6.2 arranged in parallel, and
first and second auxiliary control solenoid valves 26.1 and 26.2 respectively arranged on the first auxiliary control pipe 6.1 and on the second auxiliary control pipe 6.2 so as respectively to control the first control valve 8.1 and the second control valve 8.2.

Moreover, the control system 1 from FIG. 7 comprises first and second auxiliary control sensors 27.1 and 27.2 that are configured so as to generate a respective failure signal if the first and/or second control valves 8.1 and 8.2 do not reach their respective open position.

In the event of an incident, for example if the first auxiliary control solenoid valve 26.1 does not remain in the open position, then the first auxiliary control sensor 27.1 detects the absence of end of opening travel of the first control valve 8.1, and the first auxiliary control sensor 27.1 generates an alarm signal for a maintenance operative to carry out maintenance operations. The second control valve 8.1 remains open, which guarantees the arrival of the control fluid in the control pipes 4 and at the flow valves 2.1, 2.2 and 2.4.

Moreover, the control system 1 from FIG. 7 differs from the control system 1 from FIG. 4, in particular because the safety device 10 from FIG. 7 comprises:
first and second evacuation valves 16.1 and 16.2 arranged in series on the same evacuation pipe 12,
first and second auxiliary evacuation pipes 14.1 and 14.2 arranged in parallel,
first and second auxiliary evacuation solenoid valves 28.1 and 28.2 respectively arranged on the first auxiliary evacuation pipe 14.1 and on the second auxiliary evacuation pipe 14.2 so as respectively to control the first evacuation valve 16.1 and the second evacuation valve 16.2.

Moreover, the control system 1 from FIG. 7 comprises first and second auxiliary evacuation sensors 29.1 and 29.2. The first and second auxiliary evacuation sensors 29.1 and 29.2 are configured so as to generate a respective failure signal if the first and/or second evacuation valves 28.1 and 28.2 do not reach their respective closed position.

In the event of an incident, for example if the first auxiliary evacuation solenoid valve 28.1 does not remain in the closed position, then the first auxiliary control sensor 29.1 detects the absence of closure end of travel of the evacuation valve 16.1, after which the first auxiliary control sensor 29.1 generates an alarm signal so that a maintenance operative carries out maintenance operations. The second evacuation valve 16.2 remains closed which prevents the evacuation of the control fluid to the evacuation pipe 12, and therefore guarantees the arrival of the control fluid in the control pipes 4 and at the flow valves 2.1, 2.2 and 2.4.

When the reaction fluid feeding system 51 from FIG. 7 is in service, the safety device 10 is in the service configuration. The control valve 8.1 and/or 8.2 is then open or passing, whereas the evacuation valve 16.1 and/or 16.2 is closed, with the result that the control fluid circulates from the control fluid source 80 in the control pipes 4 and to the flow valves 2.1, 2.2 and 2.4, in the direction indicated by the arrow 80.4 in FIG. 7.

In the event of an incident, the safety device 10 goes to the safety configuration by placing all the valves in the safety configuration. Each control valve 8.1 and 8.2 is then closed, whereas the evacuation valves 16.1 and 16.2 are open, with the result that the control fluid is evacuated from the control pipes 4 and through the evacuation pipe 12, in the direction indicated by the arrow 4.12 in FIG. 7.

Moreover, the reaction fluid feeding system 51 from FIG. 7 differs from the reaction fluid feeding system 51 from FIG. 4, because the reaction fluid feeding system 51 from FIG. 7 comprises at least one flow valve 2.0 that is not connected to a control pipe because it is disposed on the upstream side of the safety device 10. A flow valve 2.0 of the above type can be actuated independently, which enables for example failsafe operation of all the feeding system whilst retaining control over the flow valve 2.0.

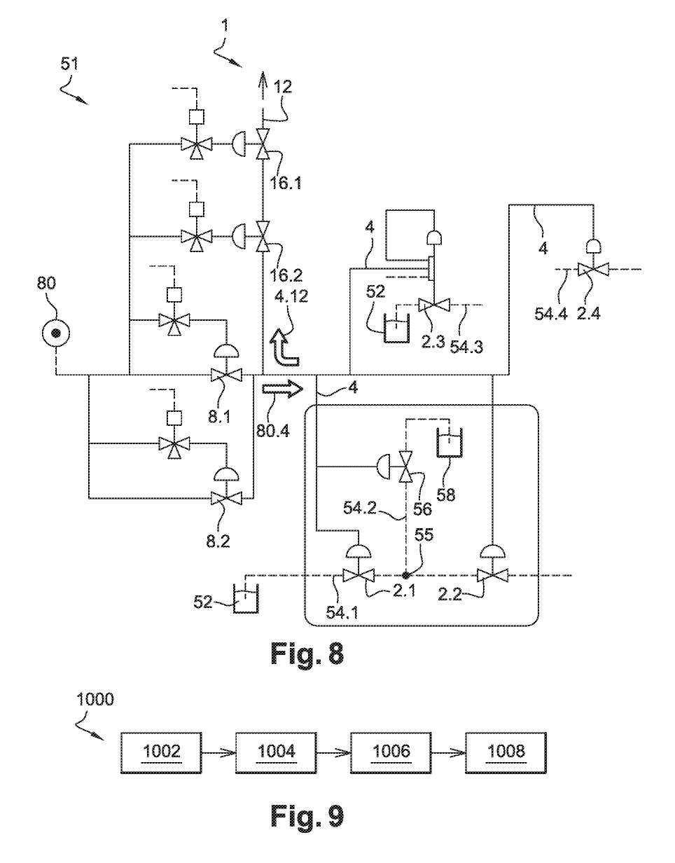

FIG. 8 illustrates a reaction fluid feeding system 51 conforming to a fourth embodiment. To the extent that the reaction fluid feeding system 51 from FIG. 8 is similar to the reaction fluid feeding system 51 from FIG. 7, the description of the reaction fluid feeding system 51 given above in relation to FIG. 7 can be transposed to the reaction fluid feeding system 51 from FIG. 8, with the exception of the significant differences stated below.

The reaction fluid feeding system 51 from FIG. 8 thus comprises a control system 1, flow valves 2.1 and 2.4, control pipes 4, a safety device 10, an evacuation pipe 12, first and second control valves 8.1 and 8.2, first and second evacuation valves 16.1 and 16.2, a container 52 with reaction fluid, channels 54.1, 54.2, 54.3 and 54.4 and a control fluid source 80.

The reaction fluid feeding system 51 from FIG. 8 differs from the reaction fluid feeding system 51 from FIG. 7, in particular because the reaction fluid feeding system 51 from FIG. 8 comprises first and second channels 54.1 and 54.2 that are connected at a junction point 55.

The first channel 54.1 is connected to the container 52. The second channel 54.2 leads to a reject port, here to a backup container 58.

Moreover, the control system 1 from FIG. 8 differs from the control system 1 from FIG. 7, in particular because the control system 1 from FIG. 8 comprises first and second flow valves 2.1 and 2.2 arranged on the first channel 54.1 on respective opposite sides of the junction point 55.

Moreover, the first and second flow valves 2.1 and 2.2 are configured to go to the closed position if the pressure of the control fluid in the control pipe 4 is below a predetermined pressure, for example below 2 or 3 bar relative.

The control system 1 from FIG. 8 further comprises an escape valve 56 arranged on the second channel 54.2 so as to convey reaction fluid in the second channel 54.2. The escape valve 56 is connected to a control pipe 4.

The escape valve 56 is configured to have i) a closed position and ii) an open position. Moreover, the escape valve 56 is configured to go to the open position if the pressure of the control fluid in the control pipe 4 is below a predetermined pressure, for example below 2 or 3 bar relative.

Of course, the present invention is not limited to the particular embodiments described in the present patent application, or to embodiments evident to a person skilled in the art. Other embodiments can be envisaged without departing from the scope of the invention, based on any element structurally or functionally equivalent to an element indicated in the present patent application.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A control system, for controlling the circulation of at least one reaction fluid in a reaction fluid feeding system, the control system comprising:
a plurality of flow valves configured to be arranged on respective channels intended to convey at least one reaction fluid, each of said flow valves being configured to have at least: i) a closed position and ii) an open position in which said at least one reaction fluid can circulate in the respective channel;
a plurality of control pipes intended to be connected to a control fluid source, the control fluid being for example compressed air, each of said flow valves being connected to a respective control pipe, a plurality of said flow valves being configured to go to the closed position if the pressure of the control fluid in the respective control pipe is below a predetermined threshold;
at least one evacuation pipe connected to each of said control pipes, so as to allow evacuation of the control fluid from each control pipe;
a safety device connected i) to each control pipe and ii) to said at least one evacuation pipe, the safety device being configured to have selectively:
i) at least one service configuration, in which the control fluid can circulate as far as each control pipe so that each of said flow valves can be placed in a respective open position; and
ii) a safety configuration, in which the control fluid can circulate from each of said flow valves through said at least one evacuation pipe so that said flow valves are placed in the closed position if the pressure of the control fluid in said control pipes is below the predetermined threshold.

17. The control system as claimed in claim 16, in which the safety device comprises a safety solenoid valve having at least three ports, the three ports including:
i) a first port intended to be connected to the control fluid source;
ii) a second port connected to the control pipes; and
iii) a third port connected to said at least one evacuation pipe;
the safety device being configured to place the safety solenoid valve alternately:
in a service configuration, in which the first port is connected to the second port; and
a safety configuration, in which the second port is connected to the third port.

18. The control system as claimed in claim 16, in which the safety device comprises at least:
an auxiliary control pipe intended to be connected to the control fluid source;
at least one control valve connected to each control pipe, said at least one control valve comprising a blocking member connected to the auxiliary control pipe, the blocking member being configured to place said at least one control valve selectively i) in a closed position and ii) in at least one open position, said at least one control valve being configured to go to the closed position if the pressure of the control fluid in the auxiliary control pipe is below a predetermined safety threshold;
an auxiliary evacuation pipe intended to be connected to the control fluid source; and
at least one evacuation valve on said at least one evacuation pipe, said at least one evacuation valve comprising a blocking member connected to the auxiliary evacuation pipe, the blocking member being configured to place said at least one evacuation valve selectively i) in a closed position and ii) in at least one open position, said at least one evacuation valve being configured to go to the open position if the pressure of the control fluid in the auxiliary evacuation pipe is below a predetermined evacuation threshold.

19. The control system as claimed in claim 18, in which said at least one auxiliary control pipe is equipped with an auxiliary control solenoid valve having i) a passage position, in which the control fluid circulates in said at least one auxiliary control pipe, and ii) an escape position, in which the control fluid escapes from said at least one auxiliary control pipe; and
the auxiliary control solenoid valve being configured to go from the passage position to the escape position if the electrical power supply of the respective auxiliary control solenoid valve is interrupted.

20. The control system as claimed in claim 19, in which the safety device comprises:
first and second control sections arranged in parallel and each connected to said control pipes;
first and second control valves arranged in parallel on the control sections;
first and second auxiliary control pipes arranged in parallel; and
first and second auxiliary control solenoid valves that are intended to be connected to the control fluid source and are respectively arranged on the first auxiliary control pipe and on the second auxiliary control pipe so as respectively to control the first control valve and the second control valve.

21. The control system as claimed in claim 20, the control system further comprising first and second auxiliary control sensors configured to generate a respective failure signal if the first and/or the second control valve does not reach its respective open position.

22. The control system as claimed in claim 18, in which said at least one auxiliary evacuation pipe is equipped with an auxiliary evacuation solenoid valve having i) a passage position, in which the control fluid circulates in said at least one auxiliary evacuation pipe, and ii) an escape position, in which the control fluid escapes from said at least one auxiliary evacuation pipe,
said at least one auxiliary evacuation solenoid valve being configured to go from the passage position to the escape position if the electrical power supply of said at least one auxiliary evacuation solenoid valve is interrupted.

23. The control system as claimed in claim 22, further comprising:
first and second evacuation valves arranged in series on the same evacuation pipe;
first and second auxiliary evacuation pipes arranged in parallel; and
first and second auxiliary evacuation solenoid valves respectively arranged on the first auxiliary evacuation pipe and on the second auxiliary evacuation pipe so as respectively to control the first evacuation valve and the second evacuation valve.

24. The control system as claimed in claim 23, further comprising first and second auxiliary evacuation sensors respectively arranged on the first and second evacuation valves, the first and second auxiliary evacuation sensors being configured so as to generate a respective failure signal if the first and/or the second evacuation valve does not reach its respective closed position.

25. The control system as claimed in claim 16, in which at least one of said flow valves is configured to have i) a closed position and ii) a single open position, said at least one flow valve being configured to go to the open position if the pressure of the control fluid in the respective control pipe is below a predetermined threshold.

26. The control system as claimed in claim 16, further comprising a plurality of regulation members, each regulation member being configured to regulate the pressure of the control fluid in a respective control pipe, so as selectively to place the respective flow valve in a plurality of open positions.

27. A reaction fluid feeding system, for feeding with at least one reaction fluid at least one consumption member, a reaction fluid being for example a hydrocarbon, the reaction fluid feeding system comprising:
a container configured to contain the reaction fluid;
a plurality of channels connected to said at least one container and configured for the circulation of said at least one reaction fluid;
a control system as claimed in any one of the preceding claims, each flow valve being adapted selectively to prevent or to allow the circulation of said at least one reaction fluid in a respective channel; and
a control fluid source configured to supply a control fluid to the control system.

28. The reaction fluid feeding system as claimed in claim 26, comprising first and second channels that are connected at a junction point, the control system comprising first and second flow valves arranged on the first channel on respective opposite sides of the junction point;
each of the flow valves being configured to have i) a closed position and ii) at least one open position, the flow valves being configured to go to the closed position if the pressure of the control fluid in the respective control pipe is below a predetermined pressure;
the control system further comprising an escape valve arranged on the second channel so as to convey said at least one reaction fluid in the second channel, the second channel being intended to be connected to a reject port; and
the escape valve being connected to a control pipe, the escape valve being configured to have i) a closed position and ii) at least one open position, the escape valve being configured to go to the open position if the pressure of the control fluid in the control pipe is below a predetermined pressure.

29. A method for feeding at least one consumption member with at least one reaction fluid, said at least one reaction fluid being for example a hydrocarbon, the feeding method comprising the steps of:
providing a reaction fluid feeding system as claimed in claim 26;
connect each of said control pipes to the control fluid source;
place the safety device in the service configuration; and
subject each of said control pipes to a control fluid pressure above a predetermined threshold, so as to place each flow valve in a respective open position, and thus to convey said at least one reaction fluid in the channels.

30. A method of separating air by cryogenic distillation comprising a control system as claimed in claim 16.
